(19) United States
(12) Patent Application Publication
(10) Pub. No.: US 2018/0343711 A1
(43) Pub. Date: Nov. 29, 2018

(54) DEVICE FOR GENERATING AND TRANSMITTING HIGH-FREQUENCY WAVES (HF WAVES)

(71) Applicant: Miele & Cie. KG, Guetersloh (DE)

(72) Inventors: Thomas Wixforth, Guetersloh (DE); Andre Kersting, Wadersloh (DE)

(21) Appl. No.: 15/985,789

(22) Filed: May 22, 2018

(30) Foreign Application Priority Data
May 24, 2017 (DE) 10 2017 111 319.3

(51) Int. Cl. H05B 6/68; H05B 6/64; H05B 6/66; H01P 5/107

(52) U.S. Cl. CPC H05B 6/687; H01P 5/107; H05B 6/666; H05B 6/6414

(57) ABSTRACT

A device for generating and transmitting high-frequency (HF) waves which are generated by an HF generating unit and conducted through a hollow waveguide into a treatment chamber of an appliance to apply microwave energy to goods to be treated therein includes: a circuit board; and the hollow waveguide. The hollow waveguide includes a housing made of metal and at least two housing parts. The housing of the hollow waveguide is connected to the circuit board. The circuit board has mounted thereon a circuit arrangement for generating HF waves and that includes a power transistor and an HF conductor structure leading into the hollow waveguide. The HF conductor structure has an HF transition structure for converting a circuit board conductor mode to a hollow waveguide mode in order to introduce HF waves into the hollow waveguide. The circuit board carrying the HF transition structure is disposed between the housing parts.

### CROSS-REFERENCE TO PRIOR APPLICATION

Priority is claimed to German Patent Application No. DE 10 2017 111 319.3, filed on May 24, 2017, the entire disclosure of which is hereby incorporated by reference herein.

### FIELD

The present invention relates to a device for generating and transmitting high-frequency waves (HF waves) which are generated by an HF generating unit and conducted through a hollow waveguide into the treatment chamber of an appliance to apply microwave energy to goods to be treated therein.

### BACKGROUND

As is generally known, microwaves and the associated high-frequency technology have been used for a long time in microwave ovens to heat foods in household and commercial environments. Microwave technology is also used in other industrial and medical fields, with special frequency ranges being allowed for such applications. For example, an ISM frequency band of from 902 to 928 MHz and another one from 2400 to 2500 MHz are available for such purposes.

In conventional microwave ovens, the high-power microwaves needed are generated by means of a magnetron (microwave electron tube) and conducted through a hollow waveguide into the cooking chamber of a cooking appliance. A disadvantage with using a magnetron is, inter alia, that complex apparatus is required for high-frequency generation, but nevertheless certain, not insignificant drawbacks of this technology have to be accepted. A significant problem in this context is, for example, that the cooking process cannot be optimally controlled and that different levels of doneness in the food are unavoidable.

For this reason, efforts and proposals have been made for some time to dispense with magnetrons and use power semiconductors for microwave generation (see Elektronik [Electronics] 17/2016, page 40 ff: “Moderne Funktechnik zum Kochen” [Modern Radio Technology for Cooking]). The development in the field of power semiconductors, which is by now very advanced, can be used for this purpose, with the required microwave energy being supplied by a power transistor in the output stage of a high-frequency generating unit.

The heretofore known embodiments in which microwave energy is generated by power semiconductors have the disadvantage that expensive and sometimes lossy coaxial cables and coaxial connectors have to be used for transmitting the high-frequency energy from the output stage transistor to the cooking chamber.

### SUMMARY

In an embodiment, the present invention provides a device for generating and transmitting high-frequency (HF) waves which are generated by an HF generating unit and conducted through a hollow waveguide into a treatment chamber of an appliance to apply microwave energy to goods to be treated therein, the device comprising: a circuit board; and the hollow waveguide, the hollow waveguide comprising a housing made of metal and including at least two housing parts, the housing of the hollow waveguide being connected to the circuit board, wherein the circuit board has mounted thereon a circuit arrangement configured to generate HF waves and that includes a power transistor and an HF conductor structure leading into the hollow waveguide, the HF conductor structure having an HF transition structure configured to convert a circuit board conductor mode to a hollow waveguide mode in order to introduce HF waves into the hollow waveguide, and wherein the circuit board carrying the HF transition structure is disposed between the housing parts of the hollow waveguide.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a simplified block diagram showing the electronic high-frequency generating and transmission unit from which the HF waves are conducted into the cooking chamber of a cooking appliance;

FIG. 2 is a perspective view showing an inventive embodiment of the hollow waveguide in conjunction with a portion of the circuit board on which the transition structure for introducing the HF waves into the hollow waveguide is disposed, the transition structure being formed by a circuit board conductor and a monopole-like radiating element;

FIG. 3 is a view similar to FIG. 2, but additionally showing a heat-dissipating component in the form of a heat sink;

FIG. 4 is a view similar to FIG. 2, showing an alternative embodiment of a hollow waveguide;

FIG. 5 is a view of the hollow waveguide similar to that of FIG. 4, but additionally also showing a heat-dissipating component in the form of a heat sink;

FIG. 6 is a view of a hollow waveguide as shown in FIG. 4, except that a measuring device formed by at least two sensing elements for measuring forward-directed and backward-directed waves is provided in the hollow waveguide in addition to the radiating element;

FIG. 7 is a view of a hollow waveguide configured like that shown in FIG. 4, but in which a radiating element for introducing the HF waves into the hollow waveguide is formed as a dipole-like structure;

FIG. 8 is a view similar to that of FIG. 7, except that the radiating element for introducing the high-frequency waves is formed as a loop-like structure;

FIG. 9a is a perspective partial view showing the hollow waveguide and the circuit board and illustrating the attachment of the power transistor for high-frequency generation;

FIG. 9b is a cross-sectional view taken along section line S in FIG. 9a;

FIG. 10 is a perspective view of a further embodiment where the radiating element and the sensing elements of the measuring device are disposed on separate circuit boards and where the housing assembly for the hollow waveguide is modified accordingly.

### DETAILED DESCRIPTION

In an embodiment, the present invention provides a device for high-frequency generation and for transmitting microwaves.

In an embodiment, the present invention provides an appliance for different fields of application which is designed with the features of device according to the present invention.

Moreover, in an embodiment, the present invention provides a method for controlling and operating a device for generating and transmitting high-frequency (HF) waves (44) which is designed in accordance with the present invention.

The present invention may be used to advantage, in particular, in all cooking appliances in which the goods to be treated are to be exposed to microwave energy, for example, for cooking, heating and defrosting foods.

However, the present invention is not limited to these applications, since the advantages achievable by the invention are also applicable to other treatment processes in which goods to be treated are to be influenced through application of high-frequency energy, such as, for example, the drying of laundry. Also conceivable are applications in medical fields in which microwave energy is used in known manner for certain applications.

The advantages generally attainable by the present invention reside, in particular, in that the HF wave energy or power generated by power transistors can be conducted in an efficient, robust and low-loss manner toward a treatment chamber, which may, for example, be the cooking chamber of a cooking appliance for preparing and cooking foods. This is made possible by an inexpensive-to-manufacture device for generating and transmitting high-frequency waves (HF waves) which are generated by an HF generating unit equipped with power semiconductors and conducted into a hollow waveguide via a circuit board structure configured in accordance with the present invention, and from the hollow waveguide into the treatment chamber of an appliance to apply microwave energy to goods to be treated therein.

A circuit board has arranged thereon HF circuits, HF conductors, HF layout structures for high-frequency generation and, in addition, also an HF conductor structure which leads into the hollow waveguide and forms an HF transition structure via which the transition from a circuit board conductor mode to a hollow waveguide mode is accomplished.

The hollow waveguide has a housing which is made of metal and configured in the form of a rectangular duct and is formed by at least two housing parts. The housing parts may be easily manufactured as sheet-metal parts by stamping and bending. In accordance with the present invention, the circuit board carrying the HF transition structure is positioned between the two housing parts in such a way that the circuit board portion carrying the HF transition structure is enclosed by the two housing parts. The waveguide housing formed by the housing parts may be constructed in various forms. In particular, it is also possible, for example, to provide the housing parts, or certain parts of a housing part, with a cooling element to provide for adequate heat dissipation at critical points of the assembly. In an advantageous embodiment, a housing part of the hollow waveguide and a heat sink may be configured as a single piece.

Further, the HF transition structure can be implemented on the circuit board in various different forms to allow the HF waves to be radiated or introduced into the hollow waveguide.

In a first embodiment, a radiating element having a monopole-like conductor structure and a circuit board conductor leading to the radiating element are used for introducing the HF waves into the hollow waveguide.

In another embodiment, for purposes of introducing the HF waves into the hollow waveguide, the radiating element is configured with a dipole-like conductor structure and the stripline leading to the radiating element carries a symmetrical circuit board conductor mode. Furthermore, the radiating element may be formed as a loop-like conductor structure in the manner of a wire loop, with the circuit board conductor to the radiating element also carrying a symmetrical circuit board conductor mode. In the two aforementioned cases, the symmetrical circuit board conductor may also be configured differentially.

A particularly advantageous refinement of the aforedescribed basic structure according to the present invention can be implemented by incorporating into the hollow waveguide a measuring device which includes at least two sensing elements for measuring forward-directed and backward-directed HF waves. The sensing elements perform, as it were, the function of receiving antennas. With this, the forward-directed HF waves intended for microwave treatment and the HF waves that propagate backward from the treatment chamber due to reflections can be captured and analyzed in terms of magnitude and phase. The two sensing elements are formed by two monopole-like conductor structures on the circuit board.

The sensing elements are connected to an analyzing and control unit, each via a respective circuit board conductor leading into the hollow waveguide. In a suitably configured analyzing and control unit, the measurements may then be analyzed, determining the magnitudes and/or phases of forward and backward propagating waves, and the measurements may be used in algorithms for controlling the HF generation.

This makes it possible, for example, to configure a monitoring device in terms of control in such a way that it protects the power transistor in the HF generating unit from excessive voltages caused by backward propagating HF waves. This eliminates the need for the circulators heretofore employed for this purpose.

Overall, this design makes it possible to apply the proper amount of microwave radiation and to control the application of microwave radiation as a function of the condition of the goods being treated. Thus, magnitudes and possibly also phases of the forward propagating waves and the waves that propagate backward, for example, due to reflections, can be measured, making it possible to advantageously influence the treatment result.

A device for high-frequency generation designed in accordance with the present invention can be manufactured in large quantities using conventional and commonly used electronics mass production means. Expensive additional technologies and special components, such as circuit boards having relatively thick copper layers or using special materials (e.g., Teflon) in place of conventional substrate materials (FR4), may be avoided. In addition, the heat dissipation required, in particular, for the power transistors can be ensured by simple heat sink constructions and using simple and cost-effective means.

For purposes of conducting the HF waves, conventional circuit board conductors are used on the circuit board and on the metal parts present in the circuit path. These circuit board conductors may be configured in a known manner as striplines. In an advantageous embodiment, inverted microstrip lines are also used for certain circuit paths. These microstrip lines are low-loss and also inexpensive to manufacture.

Dissipative materials may be installed inside the hollow waveguide to attenuate the HF waves that propagate backward through the hollow waveguide. This also makes it possible to improve the overload protection for the power transistor.

In another embodiment, in addition to the aforedescribed measures, the device for generating HF waves may be equipped with a temperature sensor which, in conjunction with the control and monitoring device, ensures that the relatively expensive power transistor is not damaged.

Moreover, an advantageous side effect can be obtained if the output stage power transistor is mountable on the circuit board or a housing part connected to the circuit board or on a portion of a heat sink in such a way that it is easily replaceable, which allows for inexpensive repair in the event of failure.

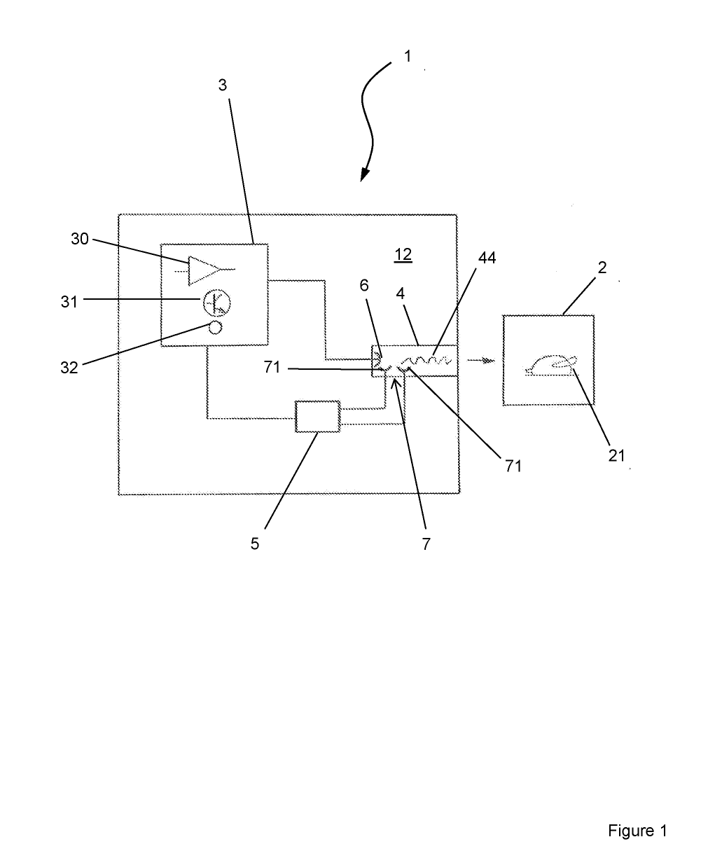

FIG. 1 shows, in simplified block diagram form, an application where a device 1 for generating and transmitting high-frequency waves 44 (HF waves) provides the microwave energy that is intended to heat the food product 21 to be cooked in the symbolically drawn cooking chamber 2 of a cooking appliance.

In device 1 for generating and transmitting HF waves 44, only those units which are necessary to illustrate the invention are shown arranged on a circuit board 12. To this end, therefore, only HF generating unit 3, hollow waveguide 4 and an analyzing and control unit 5 are shown in the drawing. Indicated in HF generating unit 3 are an HF power amplifier 30 for generating high frequency waves, a power transistor 31 as well as a temperature sensor 32.

Shown symbolically in hollow waveguide 4 are a radiating element 6 for introducing HF waves 44 and a measuring device 7 in the form of two sensing elements 71 which can be used to determine the magnitude and phase of forward and backward propagating waves in hollow waveguide 4, these sensing elements 71 being connected to an analyzing and control unit 5.

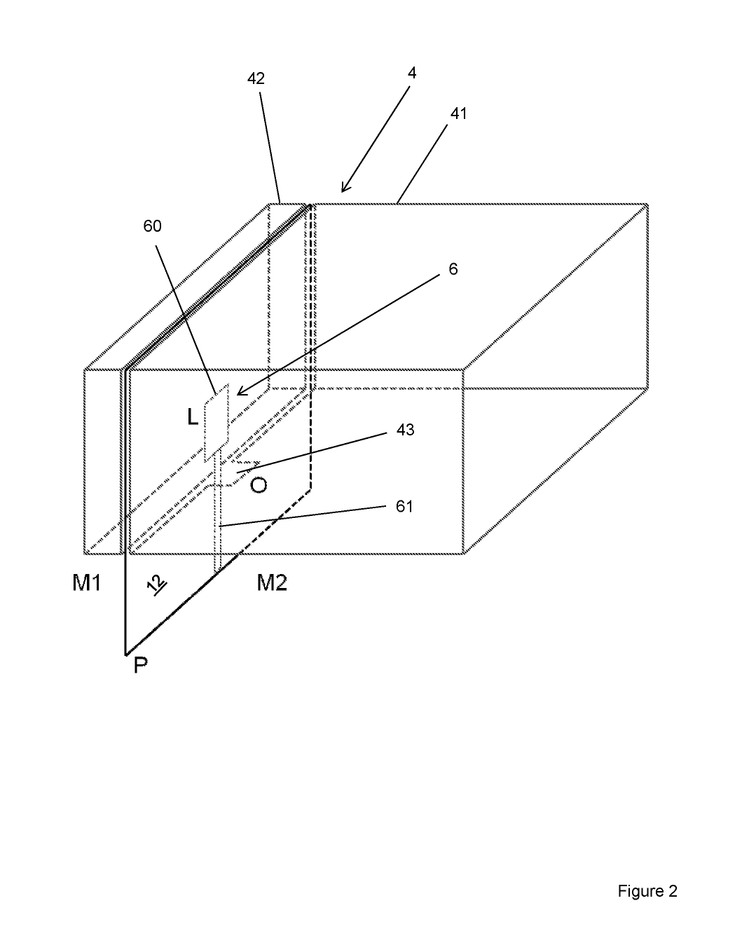

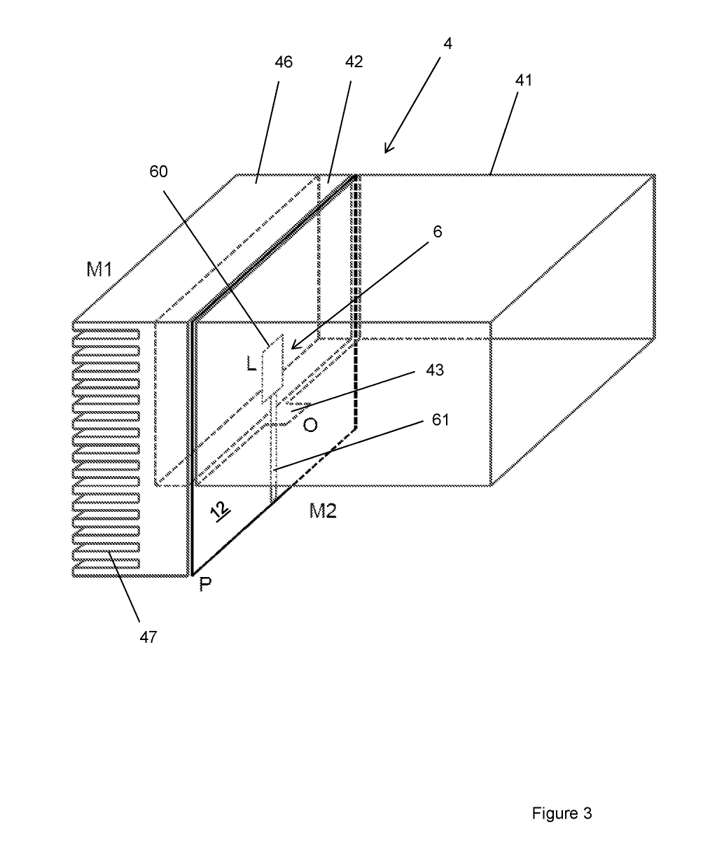

FIGS. 2 and 3 depict a first embodiment, in which the basic construction of the housing of hollow waveguide 4 is implemented. In this exemplary embodiment, HF waves 44 generated by HF generating unit 3 are introduced from circuit board 12 into hollow waveguide 4 via a monopole-like conductor structure. Thus, in conjunction with hollow waveguide 4, an HF transition structure from a circuit board conductor mode to a hollow waveguide mode is created in this region of circuit board 12.

The housing of hollow waveguide 4 is made of metal and preferably has a rectangular hollow structure. The housing includes two housing parts 41, 42 which are connected to circuit board 12, the housing parts 41, 42 enclosing the region of circuit board 12 that carries the HF transition structure.

For this purpose, this exemplary embodiment uses a circuit board conductor 61 which leads through an opening 43 located in one of housing parts 41 to a monopole-like radiation element 6 to conduct HF waves 44 generated by HF generating unit 3 into hollow waveguide 4. In this embodiment, circuit board 12 carrying the HF transition structure is disposed between the two housing parts 41, 42 transversely to the longitudinal direction of hollow waveguide 4. In advantageous embodiments, circuit board conductor 61 may be in the form of striplines, which may also take the form of microstrip lines.

Depending on the particular application and the installation conditions of the HF generating unit in the appliance, the output aperture of waveguide 4 may be oriented and configured such that the HF waves can be conducted in all three directions. Thus, the output aperture may be oriented horizontally, vertically or laterally.

FIG. 3 shows the same embodiment as FIG. 2, except that here a heat sink 46 is provided at circuit board 12 with housing part 42 of hollow waveguide 4 to provide adequate heat dissipation. Heat sink 46 is formed with cooling fins 47 in a known manner. In a preferred embodiment, housing part 42 and heat sink 46 are formed as a single piece.

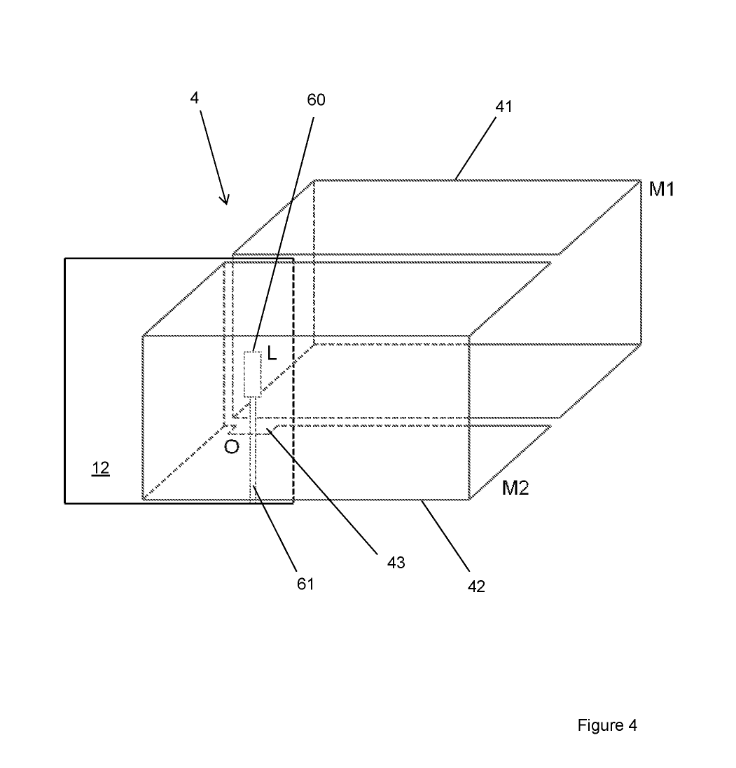

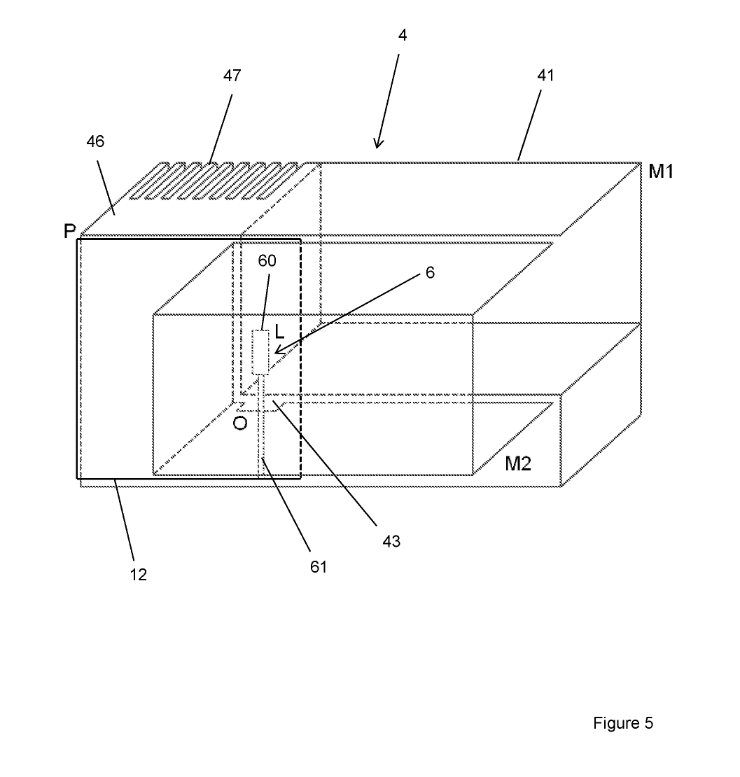

FIGS. 4 and 5 show a construction in which, compared to FIGS. 2 and 3, the housing of hollow waveguide 4 has a modified shape and circuit board 12 carrying the HF transition structure is inserted in the longitudinal direction of hollow waveguide 4. The portion of circuit board 12 that carries the HF transition structure is preferably disposed in the central region of hollow waveguide 4 between the two housing parts 41, 42, this portion being positioned at the beginning of the wave propagation path formed in hollow waveguide 4.

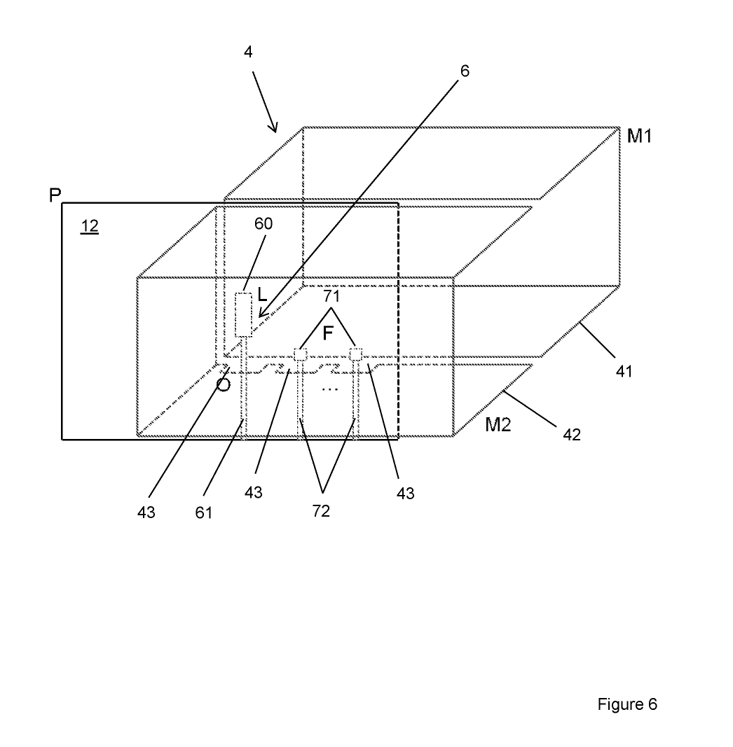

FIG. 6 shows an embodiment which is refined compared to FIGS. 1 through 5 and which, in addition, has at least two sensing elements 71 disposed in hollow waveguide 4 for measuring forward-directed and backward-directed HF waves. These sensing elements 71 are connected to an analyzing and control unit 5, each via a respective conductor 72 leading into hollow waveguide 4. Via openings 43 in a housing part 42 of hollow waveguide 4, these conductors 72 are led to sensing elements 71 in hollow waveguide 4.

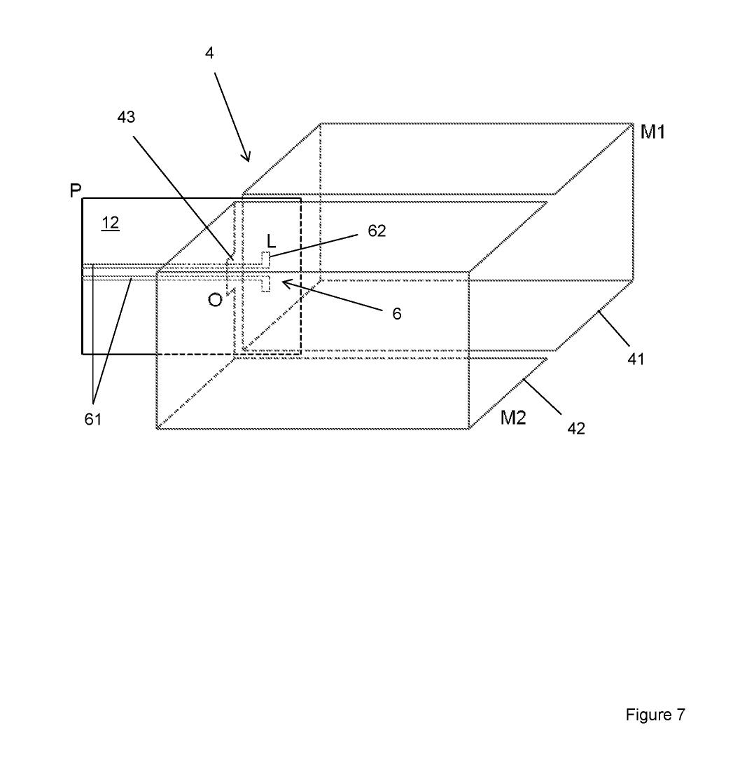

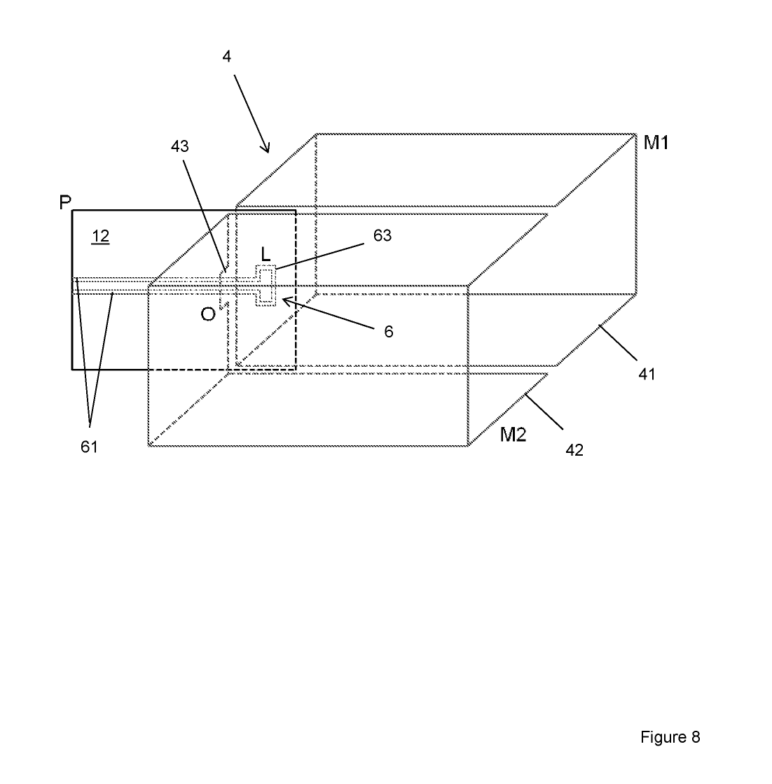

FIGS. 7 and 8 show further embodiments in which the HF transition structure provided in hollow waveguide 4 has a modified shape compared to the aforedescribed embodiments.

FIG. 7 shows an HF transition structure where a radiating element 62 having a dipole-like conductor structure is provided for introducing HF waves 44 into hollow waveguide 4, and where circuit board conductor 61 to radiating element 62 carries a symmetrical conductor mode.

In contrast, in FIG. 8, radiating element 63 is modified in that it has a loop-like conductor structure for introducing HF waves 44 into hollow waveguide 4, with the circuit board conductor 61 to radiating element 63 also carrying a symmetrical conductor mode.

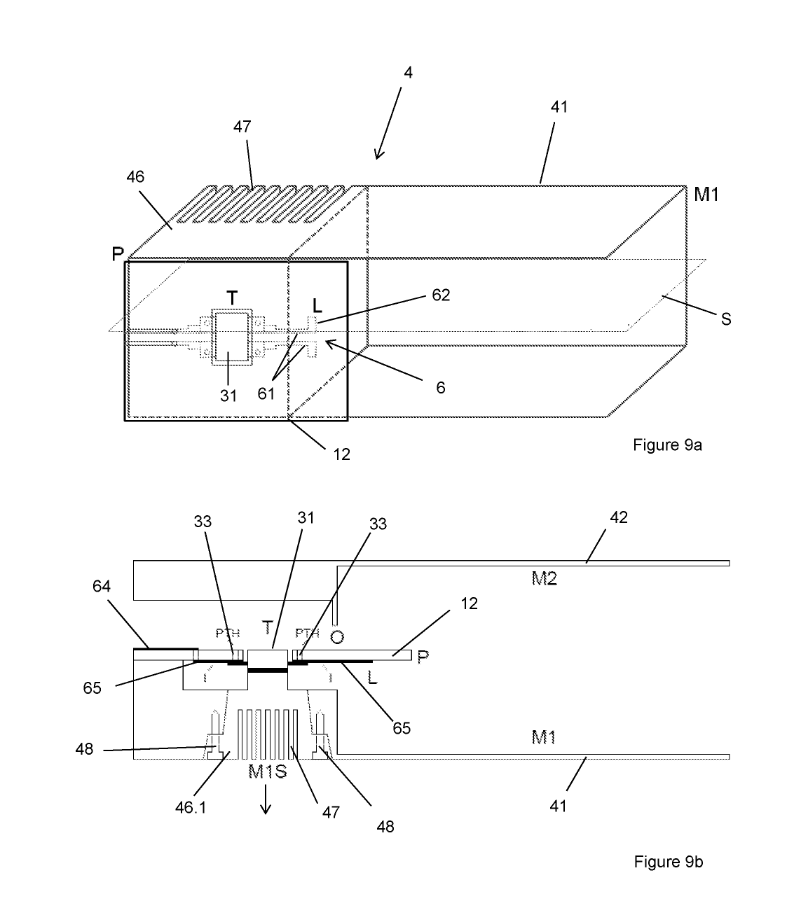

FIG. 9 shows an exemplary embodiment in which the attachment of power transistor 31 is of primary concern and which is intended to allow for easier replacement thereof in the event of repair. In FIG. 9a, hollow waveguide 4 is represented only by its housing part 41 and circuit board 12 carrying power transistor 31, but without housing part 42. FIG. 9b shows a cross section through hollow waveguide 4 of FIG. 9a, taken along section line S indicated in FIG. 9a.

Power transistor 31 of HF power amplifier 30 may be attached to circuit board 12 in a known manner by soldering. However, the embodiment shown in FIGS. 9a and 9b has the advantage that power transistor 31 is removably attached to circuit board 12 or, alternatively, to a heat sink 46 disposed at circuit board 12.

One such suitable configuration is shown illustratively in FIG. 9b. Here, power transistor 31 is connected by soldering to the corresponding conductors provided on circuit board 12 for its electrical connection. The soldering points are accessible via openings 33 provided in circuit board 12, which makes it possible to create or break the soldered connection. In the present exemplary embodiment, power transistor 31 is attached to a portion 46.1 of the heat sink 46 connected to housing part 41 which portion is removable by means of the indicated screws 48, and its ground connection may be made to housing part 46.1. Thus, in the event of repair, power transistor 31 can be removed from circuit board 12 along with portion 46.1 of the heat sink and replaced after breaking the soldered connection and loosening screws 48.

This design makes it possible to break the soldered connections through the openings 33 in circuit board 12, which are formed by through-plated bores, to permit replacement of the transistor. With this configuration, it is alternatively also possible to replace the transistor together with housing part 46.1 as a unit or to attach the transistor to circuit board 12 by screws.

In the exemplary embodiment shown in FIG. 9b, it can be seen that stripline 64 disposed on circuit board 12 is configured as inverted microstrip lines 65 ahead of and behind the connection of power transistor 65. These microstrip lines are low-loss and also inexpensive to manufacture.

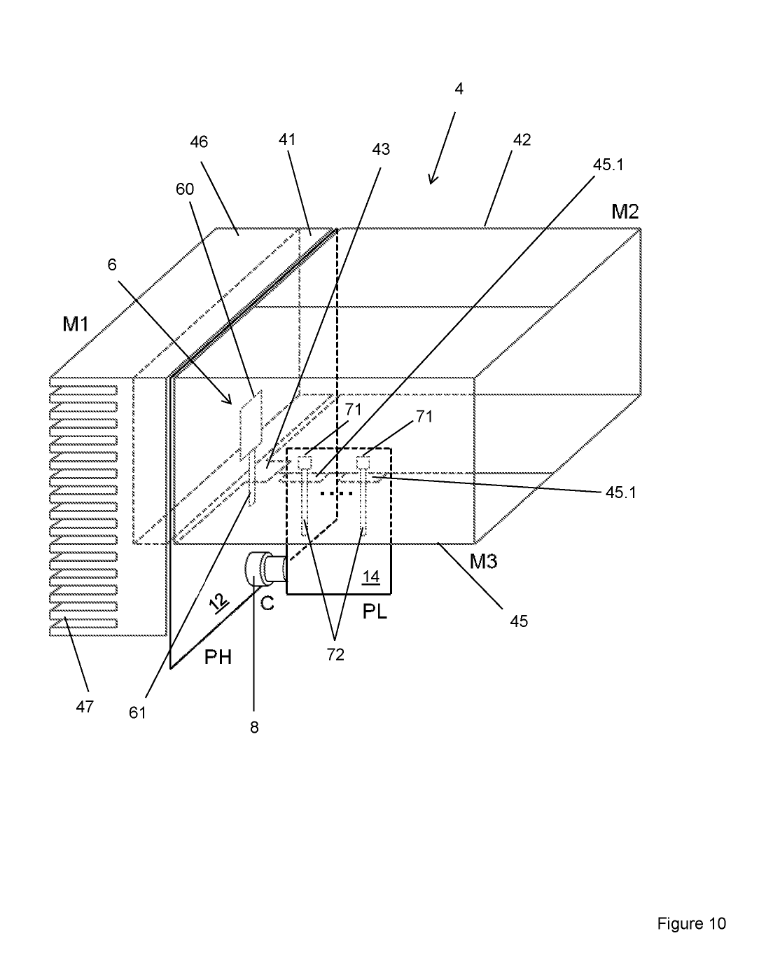

FIG. 10 shows another embodiment of a device for generating and transmitting high-frequency waves, where radiating element 6 and sensing elements 71 are mounted on separate circuit boards 12 and 14. In this case, moreover, the housing for hollow waveguide 4 is formed by three housing parts 41, 42 and 43. As shown in the drawing, these housing parts are assembled in such a way that circuit board 12 carrying the HF transition structure and circuit board 14 carrying sensing elements 71 can be positioned at different locations in hollow waveguide 4. This alternative construction provides the advantage that less expensive circuit boards may be used for mounting sensing elements 71 compared to circuit board 12 carrying the HF transition structure.

With the embodiment shown in FIG. 10, advantageously only circuit board 12 carrying HF generating unit 3 has to be manufactured as a high-power design, while a low-power design is sufficient for circuit board 14 carrying the measuring device and possibly additional low-power circuits.

In the embodiment shown here, the housing for hollow waveguide 4 is—in terms of structure—a combination of the exemplary embodiments of the waveguide housing shown in FIGS. 2 through 9. Circuit board 12 carrying HF generating unit 3 is disposed with the HF transition structure portion transversely between housing part 41 and the two housing parts 42 and 45 oriented in the longitudinal direction, while circuit board 14 carrying the measuring device including sensing elements 71 is positioned between housing parts 42 and 45. Housing part 45 also has openings 44 for conductors 72 leading to sensing elements 71. Circuit boards 12 and 14 may be interconnected by coaxial PCB connector 8 indicated in the drawing.

Temperature sensor 32, which has already been mentioned in connection with FIG. 1, should be positioned as close as possible to power transistor 31. This makes it possible to implement temperature measurement in combination with reliable monitoring and limiting of the transistor load.

Furthermore, hollow waveguide 4 may be provided with dissipative materials that convert HF energy to heat in a known manner. In order to prevent excessive temperatures from developing in localized regions, the materials should preferably convert the energy to heat in a spatially distributed manner. For example, a layer of dissipative material may be provided on the inner walls of the hollow waveguide. This may be implemented by means of a varnish layer or by plastic parts attached with clips. These additionally installed dissipative elements also help protect power transistor 31 from excessive voltages caused by backward-directed HF waves.

The circuit board conductors used for conducting the HF waves are advantageously configured as inverted microstrip lines. These are low-loss and inexpensive.

Due to the construction of the hollow waveguide 4 in accordance with the present invention, the therein disposed HF transition structure from a circuit board conductor to a hollow waveguide, and the therein disposed measuring device for forward-directed and backward-directed HF waves 44, in conjunction with an analyzing and control unit 5, and using the aforedescribed protective measures for power transistor 31, it is possible to dispense with the otherwise commonly used circulators known from the prior art. Altogether, this makes it possible to achieve a significant cost reduction.

In order to protect the transistor from excessive voltages and overloading, which may be caused by strong HF waves propagating back to power transistor 31, and to avoid excessive temperatures at and thermal stresses on power transistor 31, the above-described inventive embodiment may conveniently be used to implement a method having the following steps:
during a first period of time, power transistor 31 is operated with an output voltage of the HF waves rated to be so low which lies a predetermined distance below the maximum allowable value for power transistor 31,
in the process, the forward and backward propagating HF waves are measured by sensing elements 71 disposed in hollow waveguide 4, and the measurements are analyzed in algorithms for controlling the HF generation,
assuming that HF generating unit 3 and the load provided by the treatment chamber receiving HF waves 44 (e.g., cooking chamber 2) behave linearly and do not change over a predetermined period of time, an algorithm anticipates the voltage that would occur at the output of power transistor 31 if it were operated at higher input voltages,
and, depending thereon, it is determined if and at which higher input voltages power transistor 31 may be operated in a second (longer) period of time without overloading power transistor 31.

The temperature detected by temperature sensor 32 may also be taken into account in determining the maximum allowable input voltage for controlling power transistor 31. Thus, the input voltage at power transistor 31 may be controlled as a function of temperature. This provides a certain degree of safety because, for example, if the current temperature is already relatively high, power transistor 31 can then only be operated at a lower input voltage.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1. device for generating and transmitting high-frequency waves (HF waves)
   12 circuit board carrying the HF generating unit
   14 circuit board carrying the measuring device
2. cooking chamber of a cooking appliance
   21 food product
3. HF generating unit
   30 power amplifier for amplifying high-frequency waves
   31 power transistor, output stage transistor
   32 temperature sensor
   33 openings in the circuit board (through-plated bores)
4. hollow waveguide
   41 housing part (I)
   42 housing part (II)
   43 opening in a housing part
   44 high-frequency waves (HF waves) in the hollow waveguide
   45 housing part (III) 45.1 opening in housing part (45)
   46 heat sink; 46.1 removable portion of the heat sink
   47 cooling fins
   48 screws
5. analyzing and control unit
6. radiating element
   60 radiating element in the form of a monopole-like conductor structure
   61 circuit board conductor from the HF generator to the radiating element (launcher)
   62 radiating element in the form of a dipole-like conductor structure
   63 radiating element in the form of a loop-like conductor structure
   64 stripline
   65 inverted microstrip line
7. measuring device for forward and backward propagating HF waves
   71 sensing elements
   72 conductors to the sensing elements
   73 cutouts in circuit board (14)
8. coaxial PCB connector

What is claimed is:

1. A device for generating and transmitting high-frequency (HF) waves which are generated by an HF generating unit and conducted through a hollow waveguide into a treatment chamber of an appliance to apply microwave energy to goods to be treated therein, the device comprising:
a circuit board; and
the hollow waveguide, the hollow waveguide comprising a housing made of metal and including at least two housing parts, the housing of the hollow waveguide being connected to the circuit board,
wherein the circuit board has mounted thereon a circuit arrangement configured to generate HF waves, a power transistor, and an HF conductor structure leading into the hollow waveguide, the HF conductor structure having an HF transition structure configured to convert a circuit board conductor mode to a hollow waveguide mode in order to introduce HF waves into the hollow waveguide, and
wherein the circuit board carrying the HF transition structure is disposed between the housing parts of the hollow waveguide.

2. The device as recited in claim 1, wherein the HF conductor structure leading into the hollow waveguide includes a circuit board conductor and at least one radiating element configured to introduce the HF waves into the hollow waveguide.

3. The device as recited in claim 1, wherein at least two sensing elements configured to measure forward-directed and backward-directed HF waves are disposed in the hollow waveguide, the at least two sensing elements being connected to an analyzing and control unit, each via a respective conductor leading into the hollow waveguide, and
wherein the analyzing and control unit is configured such that magnitudes and/or phases of forward and backward propagating waves can be measured, and the measurements can be analyzed in algorithms for controlling the HF generation.

4. The device as recited in claim 3, wherein the circuit board conductors leading to the at least one radiating element and the at least two sensing elements disposed in the hollow waveguide each lead into an interior of the hollow waveguide through a respective opening in a wall of the hollow waveguide.

5. The device as recited in any of claim 1, further comprising a radiating element having a monopole-like conductor structure, the radiating element being configured to introduce the HF waves into the hollow waveguide.

6. The device as recited in claim 5, wherein a circuit board conductor of the radiating element carries an asymmetrical conductor mode.

7. The device as recited in any of claim 1, further comprising a radiating element having a dipole-like conductor structure, the radiating element being configured to introduce the HF waves into the hollow waveguide.

8. The device as recited in any of claim 1, further comprising a radiating element having a loop-like conductor structure, the radiating element being configured to introduce the HF waves into the hollow waveguide.

9. The device as recited in claim 8, wherein a circuit board conductor of the radiating element carries a symmetrical conductor mode.

10. The device as recited in claim 3, wherein the HF transition structure formed by the at least one radiating element and the circuit board conductor as well as the at least two sensing elements configured to measure forward-directed and backward-directed HF waves are disposed on separate circuit boards configured to be interconnected by conductors, and
wherein these circuit boards are inserted in the hollow waveguide at different locations.

11. The device as recited in claim 1, wherein the power transistor is part of an HF power amplifier and is removably mounted on the circuit board or on a housing part removably attached to the circuit board or to the housing of the hollow waveguide, and
wherein the circuit board has openings formed therein through which the mounting and contact points of the power transistor are accessible for mounting and removal thereof.

12. The device as recited in claim 1, further comprising a temperature sensor configured to sense a temperature of the power transistor, and
wherein the temperature sensor is connected to a monitoring device configured to prevent increased load on the power transistor.

13. The device as recited in claim 1, wherein the circuit board carrying the HF generating unit includes circuit board conductors configured to conduct the HF waves, and
wherein the circuit board conductors comprise inverted microstrip lines ahead of and behind the power transistor.

14. The device as recited in claim 1, further comprising dissipative materials installed inside the hollow waveguide configured to attenuate the HF waves that propagate backward through the hollow waveguide and to thereby avoid overloading of the power transistor.

15. An appliance for preparing foods, for cooking foods, for drying goods to be treated, or an appliance intended for application in the medical field,
wherein the appliance includes the device for generating and transmitting HF waves as recited in claim 1.

16. A method for controlling and operating a device for generating and transmitting HF waves as recited in claim 1, wherein the method includes the following steps:
during a first period of time, operating the power transistor with an output voltage of the HF waves that does not exceed a maximum allowable value for the power transistor;
in the process, measuring magnitudes and/or phases of the forward and backward propagating HF waves using sensing elements disposed in the hollow waveguide, and analyzing the measurements in algorithms for controlling the HF generation;
when the HF generating unit and a load provided by the treatment chamber receiving the HF waves behave linearly and state conditions thereof do not change in a load-critical manner for the power transistor over a predetermined period of time, anticipating, using an algorithm, a voltage that would occur at an output of the power transistor if the power transistor were operated at a higher input voltage; and
depending thereon, determining if and at which higher input voltages the power transistor may be operated in further periods of time without overloading the power transistor.
